(19) United States
(12) Patent Application Publication
(10) Pub. No.: US 2009/0145042 A1
(43) Pub. Date: Jun. 11, 2009

(54) INNER CLADDING OF A MOTOR VEHICLE DOOR COMPRISING A CABLE HARNESS

(76) Inventors: Hans-Helmut Mieglitz, Monheim (DE); Thorsten Meyer, Krefeld (DE); Alexander Schidan, Solingen (DE)

Correspondence Address: DICKINSON WRIGHT PLLC, 1875 Eye Street, NW, Suite 1200, WASHINGTON, DC, 20006, US

(21) Appl. No.: 12/066,137

(22) PCT Filed: Aug. 29, 2006
(86) PCT No.: PCT/EP2006/008439

§ 371 Date: Jul. 25, 2008

(30) Foreign Application Priority Data
Sep. 9, 2005 (DE) 102005043177.1

(51) Int. Cl. B60J 5/04; E05D 7/00; E06B 3/00

(52) U.S. Cl. 49/502; 16/221; 49/506

(57) ABSTRACT

An inner cladding (2) of a motor vehicle door in which a hollow plastic profile (3) within which a cable harness (12) is arranged is attached to the inner cladding (2). Furthermore, the present invention relates to a motor vehicle door comprising the inner cladding (2) according to the invention and to a method for mounting a motor vehicle door.

### CROSS REFERENCE TO RELATED APPLICATIONS

None.

### BACKGROUND OF THE INVENTION

1. Field of the Invention

The present invention relates to an inner cladding of a motor vehicle door, in which a hollow plastics profile is applied to the inner cladding, within which a cable harness is arranged. The present invention also relates to a motor vehicle door comprising the inner cladding according to the invention as well as a method for installing a motor vehicle door.

2. Related Art

Motor vehicle doors are nowadays complex components which comprise a plurality of driven units, which have to be supplied with current and/or electrical impulses. The wires required therefor have to be laid during the installation of the motor vehicle door, for example from the inner cladding, through or along the door body, which is disclosed for example in DE 195 13 850 or in DE 195 20 827. This method is, however, relatively complicated and liable to error for the worker positioned on the assembly line.

It is, therefore, an object of the present invention to provide a vehicle inner cladding which does not have the drawbacks of the prior art.

### SUMMARY OF THE INVENTION

The object is achieved by an inner cladding of a motor vehicle door in which a hollow plastics profile is applied to the inner cladding, within which a cable harness is arranged.

The inner cladding according to the invention has the advantage that it already has a plastics profile in which the cable harness is located. The cable harness is accordingly previously fully installed on or against the cladding. As a result, it is possible to install the inner cladding on the door body without the cable harness having to be guided through the door body and thus through the wet space inside the motor vehicle door. The cable harness also does not have to be installed on or along the door body. The inner cladding according to the invention may be installed exceptionally easily and rapidly. In the event of repairs, the cable harness is easily accessible.

According to the invention, the inner cladding comprises a hollow plastics profile which is applied to the inner cladding, i.e. creates a material connection, non-positive connection and/or positive connection with the inner cladding. For example, the hollow plastics profile may be bonded or welded onto the inner cladding. Moreover, there is the possibility of clipping the plastics profile to the inner cladding, or fastening with screws, rivets or the like to the inner cladding. The hollow plastics profile may be arranged on the inner face, i.e. on the face oriented in the direction of the door body.

According to the invention, a cable harness is located within the hollow plastics profile. Said cable harness is connected at one end to the units to be supplied with energy or impulses. The cable harness may comprise at its other end a connector which is sealingly connected to the plastics profile. Such a sealing connection may be achieved, for example, by the material of which the plastics profile consists, for example a rubber-like plastic, in particular EPDM, being cast or injection-molded around the plug connector.

The plastics profile may include a hinge about which the plastics profile may be pivoted, for example during installation.

In a further embodiment, the plastics profile is of multipart configuration, the parts being able to be plugged into one another.

In any case, it is advantageous, although not imperative, that the plastics profile is at least substantially watertight after the installation thereof on the door body or at the latest after fitting the door in a motor vehicle.

The plastics profile may feature a connecting means, preferably a snap connection which may be reversibly fastened, such as a clip, by means of which the plastics profile may be fastened to the body of a motor vehicle door to be manufactured.

In particular when the plastics profile consists at least partially of a rubber-like material, preferably it comprises bellows which allow a flexible handling of the plastics profile.

The inner cladding may further comprise connectors for units arranged in the body. Mating connectors of a so-called plug and play system are preferably associated with said connectors in the door body, so that the inner cladding merely has to be positioned on the door body and fastened, and the units located in the body are then immediately operational.

A further subject of the present invention is a motor vehicle door which comprises a door body, to which the inner cladding according to the invention is connected.

Said vehicle door according to the invention is exceptionally simple and thus cost-effective to install. The entire installation of the inner cladding may take place in the Y direction.

Preferably, although not necessarily, the door body comprises a recess, in which the plastics profile is at least partially arranged. As a result, it is possible that the plastics profile terminates flush with the door body and only the plug connector, which is located at the end of the plastics profile, projects in the direction of the A-pillar from the door body. Preferably, in said recess a complementary part is present for the connecting means arranged in the plastics profile. The connection between the plastics profile and the door body may be reversible. It is, however, also possible to bond the plastics profile onto the door body and/or to fasten the plastics profile to the door body by positive and/or non-positive connections.

In one preferred embodiment of the present invention, a film is arranged between the door body and the door cladding which subdivides the interior of the vehicle door into a wet space and a dry space. The film may be arranged on the inner cladding according to the invention. Said embodiment of the present invention has the advantage that, during the final installation of the motor vehicle door, the film is not present as a separate component.

The film which subdivides the vehicle door into a wet space and a dry space may, however, also be dispensed with, which results in advantages in terms of installation and cost.

A further subject of the present invention is a method for installing a vehicle door comprising a door body and the inner cladding according to the invention, in which the inner cladding and the plastics profile are connected to the door body.

The method according to the invention may include the step of, during installation the plastics profile is at least partially pivoted about a hinge.

### BRIEF DESCRIPTION OF THE DRAWINGS

The inventions are explained below with reference to FIGS. 1 to 3. These explanations are merely given by way of example and do not restrict the general inventive idea. The explanations apply equally to all subjects of the invention. In the drawings:

FIG. 1 shows an exploded view of the motor vehicle door according to the invention,

FIG. 2 shows the inner cladding with the plastics profile before the installation thereof on the door body, and

FIG. 3 shows the inner cladding and the plastics profile according to FIG. 2 after the installation thereof on the door body.

### DETAILED DESCRIPTION OF THE PREFERRED EMBODIMENTS

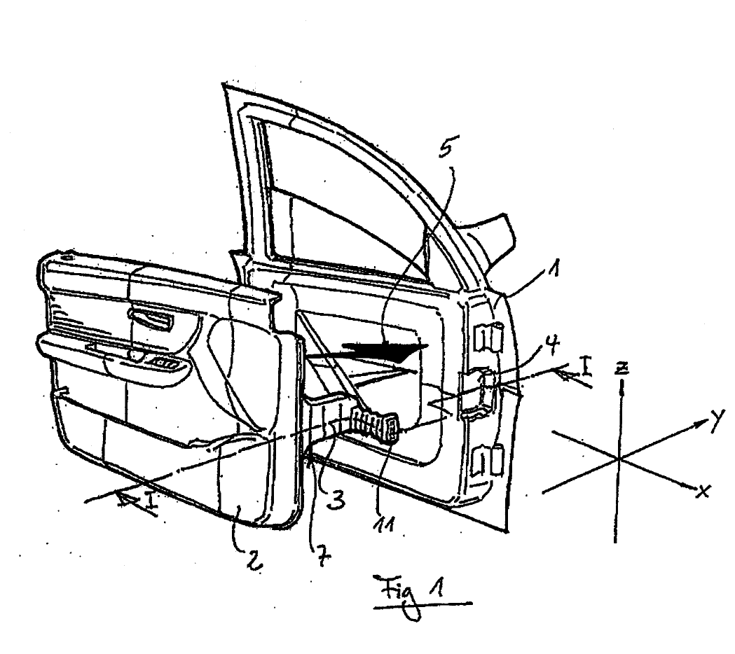

FIG. 1 shows an exploded view of the door body 1 and the door inner cladding 2 prepared for the final installation. By moving the inner cladding 2 in the installation direction 5 (Y direction), the inner cladding undertakes the function of a plug connector of a plug and play system, i.e. all units within the two installation parts 1, 2 are directed in a self-locating manner towards corresponding mating connectors and/or complementary contact parts. Applied to the inner face of the inner cladding 2 is a hollow plastics profile, within which a cable harness (not shown) is located. A plug connector 11 is arranged at the end of the hollow plastics profile 3. By selecting a material which is as flexible as possible, preferably a rubber-like material such as EPDM or the like, as well as by using a geometric shape as a result of its capacity to crease, the projecting plastics profile 3 which initially still protrudes during the positioning of the inner cladding 2 onto the door body 1 is able to cover in a flush manner the fitting recess 4 incorporated opposite in the door panel, after the inner cladding 2 has been clipped and/or screwed on, for example as a hinge point which falls into shape. After the final installation of the plastics profile, only the plug connector 11 intended for the subsequent coupling to the body projects from the fully installed vehicle door.

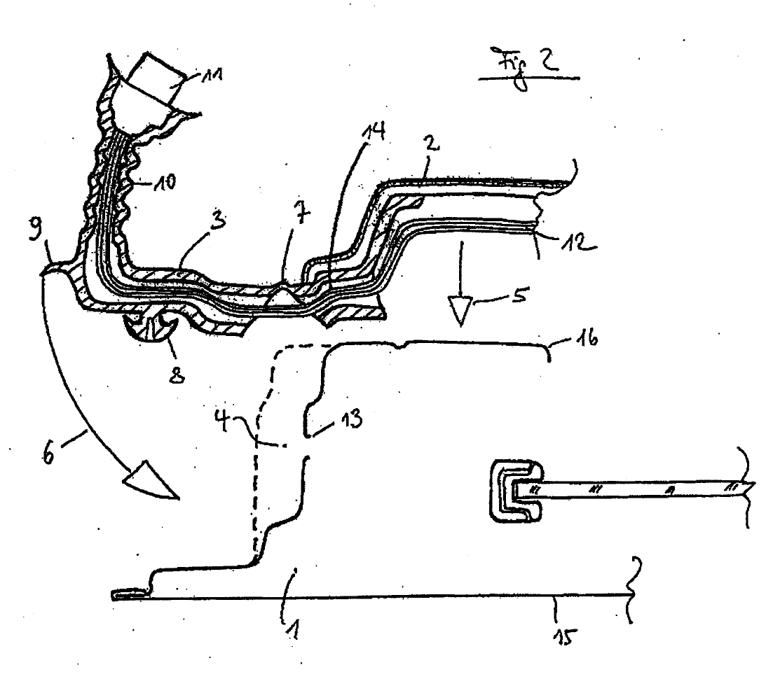

In FIG. 2 the section identified by I-I and as characterized in FIG. 1, is represented by the inner cladding 2 and the door body 1 before the final installation thereof. The hollow plastics profile 3 is arranged on the inner face of the inner cladding 2, the cable harness 12 being located in the hollow space thereof 14. The plastics profile 3 is, in the present case, made from a rubber-like material and comprises a hinge 7 about which the plastics profile may be partially folded by approximately 90° as shown by the arrow 6. The hinge 7, therefore, takes the form of connecting material below which a V-shaped notch of approximately right angle configuration is formed. This configuration thus results in a so-called “living” hinge that will not cause binding or puckering of the base material when folded in the direction of arrow 6. Moreover, the plastics profile 3 comprises a part 8 of a clip connection as well as a bellows 10 which provides a certain flexibility to the plastics profile. The plug connector 11 which is connected to the cable harness 12 is sealingly gripped by the plastics profile 3.

For installing the inner cladding 2 on the door body 1, the inner cladding 2, as shown by the arrow 5, is moved in the direction of the door inner panel 16 and connected thereto, for example clipped or screwed. The plastics profile, as shown by the arrow 6, is then pivoted by 90° and inserted into the fitting recess 4 which is located inside the door body. During the insertion or shortly afterwards, the connecting part 8 is introduced into the recess 13, in order to ensure that the plastics profile 3 remains in the pivoted position. As a result of the pivoting of the plastics profile 3, the hinge closes upon itself and is sealed. The person skilled in the art recognizes that the plastics profile may also be constructed in two parts.

In this case, it is advantageous if the plastics profile 3 is not completely made from a rubber-like material but partially from a rigid material. Moreover, the parts of the plastics profile are advantageously formed and/or arranged on the inner cladding and/or on the body, such that they may be connected to one another, for example may be plugged into one another, by a movement in the Y direction. For example, the plastics profile 3 could consist of a plastics profile projecting at a 90° angle to the cladding as a projecting adjusting element and could consist of a plastics profile located in the fitting recess 4. Advantageously, the plastics profile thus comprises soft parts for sealing and more rigid parts for pressing/plugging together. Moreover, the plastics profile 3 according to FIG. 2 comprises a sealing lip 9, which at least partially prevents water from entering into the fitting recess. The person skilled in the art recognizes that said sealing lip may also be provided with an undercut and said undercut thus creates a positive connection with the body. In this case, the connecting means 8 could be dispensed with.

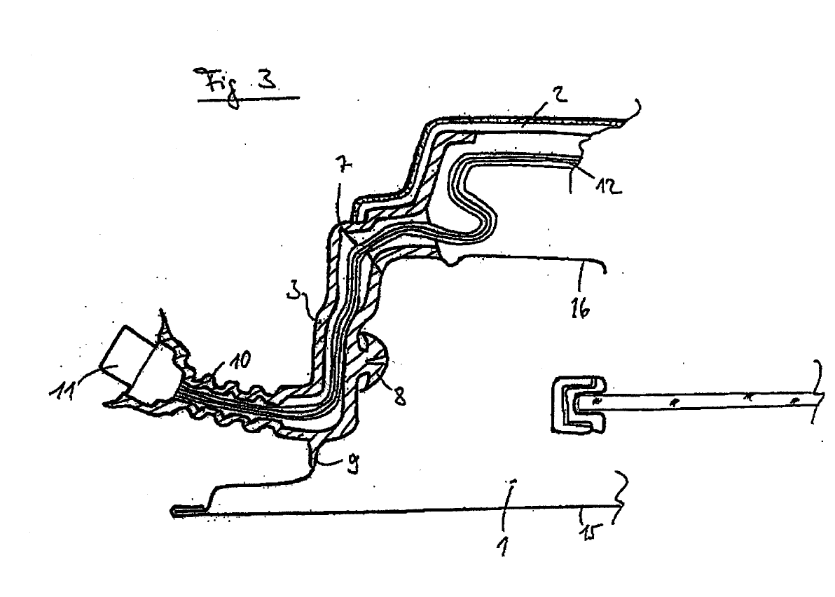

FIG. 3 shows the door according to the invention in the final installed state, with the plug connector 11 pointing in the direction of the A-pillar. By inserting the connecting means 8 into the bore 13, the plastics profile bears flush against the body and the sealing lip 9 prevents entry of liquid into the fitting recess, and thus into the hollow space located therebehind. In this state, all units within the entire door are in contact and the vehicle door is ready for final installation. As a result of the compact, integrated, flush arrangement of the plastics profile 3 on the door body, said plastics profile is well protected from damage. As the hollow plastics profile 3 is provided with a hinge 7, the inner cladding according to the invention may be supplied as a flat component and the folding of the plastics profile against the vehicle body may only be carried out during installation. The dismantling of the door inner cladding according to the invention takes place in the reverse sequence.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

### LIST OF REFERENCE NUMERALS

1 Door body
2 Door inner cladding
3 Plastics profile
4 Fitting recess
5 Installation direction of cladding
6 Installation direction of plastics profile
7 Hinge
8 Installation plug
9 Sealing lip
10 Bellows
11 Plug connector
12 Cable harness
13 Cable guide
14 Hollow space
15 Door outer panel
16 Door inner panel

1. An inner cladding (2) of a motor vehicle door, characterized in that a hollow plastics profile (3) is applied to the inner cladding (2), within which a cable harness (12) is arranged.

2. The inner cladding (2) as claimed in claim 1, further characterized in that the plastics profile (3) comprises a hinge (7).

3. The inner cladding (2) as claimed in claim 1, further characterized in that the plastics profile (3) comprises a connecting means (8), by means of which it may be fastened directly to the door body (1).

4. The inner cladding (2) as claimed in claim 1, further characterized in that the plastics profile consists of parts which may be plugged into one another, which are preferably able to be plugged-in in a partially flexible, sealing and partially dimensionally stable manner.

5. The inner cladding (2) as claimed in claim 1, further characterized in that a plug connector (11) is arranged at one end of the cable harness (12), and wherein the plug connector (11) is sealingly connected to the plastics profile (3).

6. The inner cladding (2) as claimed in claim 1, further characterized in that the plastics profile (3) comprises bellows (10).

7. The inner cladding (2) as claimed in claim 1, further characterized in that it comprises connectors for units arranged in the body.

8. The inner cladding (2) as claimed in claim 1, further characterized in that the plastics profile is formed as an adjusted part filling the body.

9. A vehicle door of a motor vehicle comprising a door body (1), to which the inner cladding (2) is connected according to claim 1.

10. The vehicle door as claimed in claim 9, further characterized in that the door body (1) comprises a recess (4), in which the plastics profile (3) is at least partially arranged, preferably with an interference fit.

11. The vehicle door as claimed in claim 10, further characterized in that the plastics profile (3) comprises a connecting means (8) adapted to connect with a complementary part (13), the complementary part (13) for the connecting means being arranged in the recess (4).

12. The vehicle door as claimed in claim 9, further characterized in that a plug connector (11) is arranged at one end of the cable harness (12), the connector (11) being oriented in the direction of an A-pillar of a motor vehicle, on which the vehicle door is installed.

13. The vehicle door as claimed in claim 9, further characterized in that a film is arranged between the door body (1) and the inner cladding (2).

14. The vehicle door as claimed in claim 13, further characterized in that the film is arranged on the inner cladding.

15. A method for installing a vehicle door comprising a door body (1) and an inner cladding (2), as claimed in claim 1, characterized in that the inner cladding (2) and the plastics profile (3) applied thereto, are connected to the door body.

16. The method as claimed in claim 15, further characterized in that the inner cladding (2) and the plastics profile (3), before the installation thereof on the door body, are in an easily transportable compact state.

17. The method as claimed in claim 15, further characterized in that during installation the plastics profile (3) is pivoted about the hinge (7).
